(19) United States
(12) Patent Application Publication
(10) Pub. No.: US 2025/0268288 A1
(43) Pub. Date: Aug. 28, 2025

(54) COMPOSITION AND METHOD FOR REDUCING THE AMOUNT OF ACRYLAMIDE IN FOOD

(71) Applicant: GIVAUDAN SA, VERNIER (CH)

(72) Inventors: Tomoichiro HONDA, Tokyo (JP); Nobuyuki JYOCHI, Tokyo (JP); Kazuya KOIZUMI, Tokyo (JP)

(21) Appl. No.: 18/859,714

(22) PCT Filed: Apr. 21, 2023
(86) PCT No.: PCT/EP2023/060393

§ 371 Date: Oct. 24, 2024

(30) Foreign Application Priority Data
Apr. 25, 2022 (GB) 2205978.6

(51) Int. Cl. A23L 5/20; A23L 5/10

(52) U.S. Cl. CPC A23L 5/27; A23L 5/11

(57) ABSTRACT

There is provided a composition comprising carnosic acid and tocopherols as acrylamide reducing agent, as well as methods and uses of such composition and products obtained when using such composition.

### TECHNICAL FIELD

The present invention relates generally to compositions able to reduce the formation of acrylamide in thermally processed food. It further relates the use of said compositions when producing thermally processed food and to methods of preparation of food with reduced acrylamide level. It also relates to food with reduced acrylamide level.

### BACKGROUND

The formation of acrylamide in food that is heated or processed at high temperatures (for example baked, fried, roasted etc) is of concern to customers, as acrylamide is classified as a probable carcinogen. Acrylamide is formed as a byproduct during the Maillard reaction that is responsible for a variety of colors and flavours in food. It mainly occurs, if food containing high amounts of asparagine and reducing sugars is heated above 120° C.

One method to prevent acrylamide formation is to lower the amount of asparagine and/or reducing sugars in the food before heating. However, this requires manipulation of the food which is a burden adding to the costs and also might have an impact on the resulting product in taste, the texture and the colour. Alternatively, asparaginase can be added to the food prior to heat treatment to reduce the formation of acrylamide.

It is desirable to provide new or improved methods for reduction of acrylamide in food.

### SUMMARY

In accordance with a first aspect of the present invention there is provided a composition for use as acrylamide reducing agent.

In accordance with a second aspect of the present invention there is provided a use of a composition as acrylamide reducing agent.

In accordance with a third aspect of the present invention there is provided a method of reducing the amount of acrylamide in food product.

In accordance with a fourth aspect of the present invention there is provided a food product with reduced acrylamide level.

In accordance with a fifth aspect of the present invention there is provided a composition for frying allowing the preparation of food with a reduced amount of acrylamide.

Certain embodiments of any aspect of the present invention may provide one or more of the following advantages:
acrylamide reducing agent,
natural product,
low/neglectable contribution to aroma,
no pre-treatment of the food required.

The details, examples and preferences provided in relation to any particular one or more of the stated aspects of the present invention will be further described herein and apply equally to all aspects of the present invention. Any combination of the embodiments, examples and preferences described herein in all possible variations thereof is encompassed by the present invention unless otherwise indicated herein, or otherwise clearly contradicted by context.

### DETAILED DESCRIPTION

The present invention is based on the surprising finding that carnosic acid in combination with tocopherols can lower the formation of acrylamides in food that is heated above 120° C.

According to the present invention, there is provided a composition comprising
a) from about 1% to about 4% by weight of the composition of carnosic acid, such as from about 1.2% to about 3.9% w/w, preferably such as about 1.5% w/w; and
b) from about 96% to about 99% by weight of the composition of tocopherols, such as from about 96.1% to 98.8% w/w, preferably such as about 98.5% w/w
   for use as acrylamide reducing agent.

An acrylamide reducing agent according to the present invention has the ability to lower, to inhibit or to prevent the formation of acrylamide.

Carnosic acid (CAS No. 3650-09-7) naturally occurs in plants of the Lamiaceae family like rosemary or sage. It is used as an anti-oxidant that mainly prevents the oxidation of unsaturated fatty acids. It is applied in food and non-food products, alone or in combination with further anti-oxidants.

Tocopherols are a group of compounds having Vitamin E activity. Actually, Vitamin E is a mixture of tocopherols and structurally related tocotrienols and plays different roles in biology. It was also identified as an anti-oxidant and is used in many applications, for example in food and in cosmetics.

For example, the tocopherols can be a mixture of alpha- (α-), beta- (β-), gamma- (γ-), and/or delta- (δ-)-tocopherol, which vary in the number and position of methyl groups at the chromanole ring. For example, the mixture can contain different amounts of the different forms of said tocopherols, resulting in a tocopherol composition.

Each of the tocopherols possess three stereocenters, and so each is a chiral molecule with eight stereoisomers. The respective D-isomers are the naturally occurring ones. For example, RRR-α-tocopherol (previously called D-α-tocopherol) is the natural stereoisomer.

For example, the tocopherol composition contains about 10-20% D-alpha-, about 0.5-5% D-beta-, about 50-70% D-gamma-, and about 20-30% D-delta-tocopherol by weight of the tocopherol composition. For example, the tocopherol composition contains about 14% alpha-, about 2% beta-, about 60% gamma-, and about 24% delta-tocopherol by weight of the tocopherol composition.

The tocopherol composition can further contain one or more of tocotrienols. For example, Vitamin E can be used as tocopherol composition further containing one or more of tocotrienols. The inventors have surprisingly found that the combination of carnosic acid and tocopherols is able to reduce the formation acrylamide during heating treatment of food. This is shown in example 1. The effect on the reduction of acrylamide formation is a synergistic effect that goes beyond the individual contribution of the individual components.

In the composition of the present invention, the ratio between carnosic acid and tocopherols is from about 1:25 to 1:80, such as 1:30, 1:40, 1:50, 1:60 or 1:70.

For example, the best results in reducing the acrylamide level when frying potato chips can be achieved when the ratio between carnosic acid and tocopherols is about 1:61, 1:62, 1:63, 1:64 or 1:65, preferably 1:62.5.

In one aspect of the present invention, the carnosic acid is provided in the form of an extract obtained from a plant of the Lamiaceae family, also referred to as “Lamiaceae extract”. As used herein, the term “Lamiaceae extract” may refer to an extract from a plant of the Lamiaceae family, preferably rosemary, sage, oregano, thyme, mints, and the following genera: Salvia (such as Salvia apiana and Salvia officinalis), Rosmarinus (such as Rosmarinus officinalis), Lepechinia, Oreganum, Thymus, Hyssopus and mixtures thereof.

In one embodiment of the present invention, the carnosic acid is provided in the form of an extract obtained from rosemary (rosemary extract).

In one aspect of the present invention, there is provided a composition comprising
a) from about 25% to about 32% by weight of the composition of rosemary extract, such as from about 27% to about 30% w/w, preferably such as about 28.5% w/w; and
b) from about 68% to about 75% by weight of the composition of tocopherols, such as from about 70% to 73% w/w, preferably such as about 71.5% w/w,
   for use as acrylamide reducing agent, with the rosemary extract containing about 4% carnosic acid.

The Lamiaceae material used for extracting the Lamiaceae extract can be any part of the plant such as leaves, roots, etc.

The Lamiaceae material may be processed before extraction, for example it can be washed, dried, milled or grounded, etc.

Particular solvents that may be used in the extraction process include water, alcohols (such as methanol, ethanol), acetone, ethyl acetate, hexane, dichloromethane, and any mixtures thereof, such as alcohol/water mixtures (such as mixtures of methanol and water). For example, the extraction solvents can be water, a water-alcohol mixture (from about 1% to about 99% alcohol in water. For example, from about 30% to about 75% alcohol in water, or from about 30% to about 50% alcohol in water, such as from about 35% or from about 40% alcohol in water), or alcohol. Particular alcohols that may be mentioned include ethanol (EtOH) and methanol (MeOH).

In particular embodiments, the extraction solvent may be a methanol-water mix, such as from about 30% to about 90% methanol in water, or from about 30% to about 50% methanol in water. For example, from about 50% or from about 80% ethanol in water. In a preferred embodiment the extraction solvent is ethanol-water mix with about 75% methanol and about 25% water.

The term “acetone extract” as used herein, refers to the extract obtained from any member of the Lamiaceae family (such as rosemary, salvia etc) when the extraction from the plant (particularly leaves) has been performed using acetone as the only solvent.

The term “alcohol extract” as used herein, refers to the extract obtained from Lamiaceae when the extraction from the plant (particularly leaves) has been performed using alcohol as the only solvent. For example, 100% methanol and/or 100% ethanol. The term “hydro-alcoholic extract’ as used herein, refers to the extract obtained from Lamiaceae (such as rosemary, salvia etc) when the extraction from the plant has been performed using a mixture of water and alcohol. For example, from about 1% to about 99% alcohol (e.g. ethanol, methanol) in water, such an extract would be termed a hydro-ethanolic extract.

A detailed procedure to prepare a Rosemary extract was described in the U.S. Pat. No. 5,859,293 (PCT W096/34534), which is incorporated herein by reference in its entirely.

For example, processes for extraction and isolation of extracts being part of the composition according to the invention may comprise (or consist essentially/consist of) the following steps:
(i) extraction of Lamiaceae leaves (such as rosemary and/or salvia which may be ground) by a suitable solvent (such as acetone or ethanol);
(ii) evaporation of the solvent; and, if required
(iii) purification of the extract (e.g. by chromatography).

In one embodiment, the temperature of extraction is in a range of from about 20° C. to about 100° C. In a particular embodiment, the temperature for extraction is in a range of from about 50° C. to about 70° C. Typically, the ratio of plant material to solvent mixture used in the extraction process varies from about 1:1 to about 1:10 on a gram to milliliter basis, such as from about 1:3 to about 1:8. The incubation period (i.e. the period during which the plant material is in contact with the solvent) is typically from about 2 hours to about 24 hours.

Mechanical energy can be applied during the extraction process. Applying mechanical energy helps to homogenize the mixture, changes the physical structure of the starting biological material and increases the extraction yields of phenolic diterpens. The amount of mechanical energy applied in the method depends on at which step applied, the type of Lamiaceae material, the amount of the starting material used in the mixture, the pH of the mixture, and the temperature of the mixture. The amount of mechanical energy also can influence the amount of time needed to complete the extraction of the

[symbol]

For example, the Lamiaceae material (such as rosemary and/or salvia) and the extraction solution (such as acetone or ethanol) may be mixed using techniques known in the art, for example using stirring, maceration, percolation or infusion, such as magnetic or mechanical stirring.

Stirring may be conducted at any suitable revolution per minute (rpm), for example, the stirring may be done from about 1 rpm or about 10 rpm or about 50 rpm to about 500 rpm. For mechanical stirring this may typically be done from about 1 rpm to 500 rpm, such as from about 10 rpm to about 200 rpm.

Devices for applying mechanical energy can be a pump, a refiner, a homogenizer, an ex-truder, a lobe pump, and/or a centrifugal pump. The mixture can be circulated in a closed-loop system that includes a pressure vessel (able to contain a heated solvent mixture), a reflux vessel, a heat exchanger, such as a shell and tube heat exchanger, and a pump for recirculating the heated mixture back to the vessel, allowing multiple passes through the pump in the system.

After the Lamiaceae material (such as rosemary and/or salvia leafs) and solvent have been incubated, the solvent is separated from residual Lamiaceae material by any suitable separation technique known in the art (like for example filtration).

Further filtration steps can be used. The solvent may be partially or totally removed by any method known in the art such as centrifugation, Rota vap, and any device allowing solvent evaporation or a liquid-liquid way of replacing the solvent.

Further filtration steps can be used. For example, in a preferred embodiment, aqueous sodium carbonate (NaHCCh) may be added to dissolve carnosic acid and other organic acids, while base insoluble substances are precipitated out. The solution may be filtered to separate from solid, and the filtrate can be further concentrated under reduced pressure. In a further step, after finishing concentration is achieved, phosphoric acid (H₃PO₄) may added and the acid insoluble substances (including carnosic acid, carnosol, and carnosic derivatives) are precipitated from the concentrated solution. Additionally, the result may be fileted and the solid precipitate may be subsequently separated from liquid and rinsed with water to remove impurities.

Sterilisation methods can be applied at any step of extraction.

As used herein, the term “Phenolic diterpenes” may refer to carnosic acid, carnosol, methylcarnosate, and other phenolic diterpene derivatives (rosmanol, isorosmanol, 11, 12-di-O-methylisorosmanol, 12-O-methylcarnosic acid, rosmanol-9-ethyl ether, circimaritin, Methylated monooxidized product of carnosic acid, genkwanin, epirosmanol, epiisorosmanol, carnosic acid derivative, epirosmanol ethyl ether, cryptotanshinone) and mixtures thereof.

For example, the composition of the invention comprises (or consist essentially/consist of)
a) at least one Lamiaceae extract (such as rosemary and/or salvia extract), and
b) tocopherols,
   wherein the Lamiaceae extract is enriched in phenolic diterpenes such as carnosic acid, carnosol, methylcarnosate, other phenolic diterpene derivatives such as rosmanol, isorosmanol, 11,12-di-O-methylisorosmanol, 12-O-methylcarnosic acid, rosmanol-9-ethyl ether, circimaritin, Methylated monooxidized product of carnosic acid, genkwanin, epirosmanol, epiisorosmanol, carnosic acid derivative, epirosmanol ethyl ether, cryptotanshinone and mixtures thereof.

In an embodiment, the composition of the invention comprises at least one Lamiaceae extract (such as rosemary and/or salvia extract) comprising at least about 1%, at least about 2%, at least about 3%, at least about 4%, at least about 5%, at least about 6%, at least about 7%, at least about 8%, at least about 9%, at least about 10%, at least about 15%, at least about 20%, at least about 30%, at least about 40%, at least about 50%, at least about 60%, at least about 70%, at least about 80%, at least about 90%, at least about 95%, or at least about 99 wt % of one or more phenolic diterpenes such as the ones described before. In a preferred embodiment, the Lamiaceae extract(s) of the composition of the invention comprises carnosic acid and/or carnosol.

In a preferred embodiment, the composition of the invention comprises at least one Lamiaceae extract (such as rosemary and/or salvia extract) comprising at least about 4% wt % of phenolic diterpenes (such as carnosic acid and/or carnosol).

In certain embodiments, the Lamiaceae extract (such as rosemary and/or salvia extract) may comprise (or consist essentially/consist of) the following phenolic diterpenes: carnosic acid and/or carnosol and the ratio between carnosic acid and carnosol is from 40:1 to 1:40, such as 30:1, 20:1, 10:1, 5:1 or 1:1.

In particular embodiments, the Lamiaceae extract (such as rosemary and/or salvia extract) may be:
substantially free of other plant material (e.g. free of plant cellulose);
substantially free of plant cells; and/or
substantially free of plant cellular matter,
substantially free of solvents
substantially free of volatile oil components.

In a particular embodiment, the Lamiacea extract is an extract wherein a majority of the volatile oil components have been removed.

As used herein, the term “volatile oil components” may refer to compounds like essential oils such as: (-)-borneol, (-)-bornyl acetate, (-)-camphor, 1,8-Cineole (eucalyptol) and verbenone.

In one embodiment the ration between the total % of phenolic diterpenes (such as carnosic acid and carnosol)/total % of volatiles oil components (such as (-)-borneol, (-)-bornyl acetate, (-)-camphor, 1,8-Cineole (eucalyptol) and verbenone) is not less than 15.

As used herein, references to a material being “substantially free” of another material may refer to the material consisting of less than 1% by weight (e.g. less than 0.1%, such as less than 0.01% or less than 0.001%, by weight) of that other material.

For example, a Lamiaceae extract with a low amount of volatile oil component has a relatively low or neglectable contribution to the aroma and taste of the composition or product it is admixed to.

In one embodiment of the present invention, instead of being provided in the form of a Lamiaceae extract, the carnosic acid may be provided from other natural resources, or may be synthetic.

In one aspect of the present invention, there is provided a composition comprising
a) from about 25% to about 32% by weight of the composition of rosemary extract, such as from about 27% to about 30% w/w, preferably such as about 28.5% w/w; and
b) from about 68% to about 75% by weight of the composition of Vitamin E, such as from about 70% to 73% w/w, preferably such as about 71.5% w/w,
   for use as acrylamide reducing agent, with the rosemary extract containing about 4% carnosic acid.

The composition of the invention may be provided in a solid or liquid form, preferably a solid form, such as a powder. By solid form, it is included that the compound may be provided as an amorphous solid, or as a crystalline or part-crystalline solid.

The composition of the present invention may be used as acrylamide reducing agent.

In one aspect of the present invention, the composition is applied to food before heating the food above 120° C.

For example, the composition of the present invention can be admixed with an oil or fat prior to the food being heated therein by any known frying technique, for example by sautéing, stir frying, pan frying, shallow frying, or deep frying.

The oil or fat to which the composition is admixed to can be selected from plant and/or vegetable oils, for example coconut oil, corn oil, cotton-seed oil, olive oil, palm oil, peanut oil (ground nut oil), rapeseed oil, including canola oil, safflower oil, sesame oil, soybean oil, sunflower oil, and mixtures thereof, or from animal fats.

In one aspect of the present invention, the composition of the present invention is applied to food before heating the food above 120° C. in such an amount that
a) the carnosic acid is present in an amount of about 4 to 20 ppm; preferably in an amount of about 8 ppm, and
b) tocopherols are present in an amount of about 400 to 600 ppm, preferably in an amount of about 500 ppm.

In one aspect of the present invention, the composition of the present invention is applied to food before heating the food above 120° C. in such an amount that
a) the rosemary extract comprising about 4% of carnosic acid is present in an amount of about 100 to 500 ppm; preferably in an amount of about 200 ppm, and
b) tocopherols are present in an amount of about 400 to 600 ppm, preferably in an amount of about 500 ppm.

For example, the composition of the present invention is applied to food like cereals, cookies, crackers, breads and rolls, and other. It means, that the composition of the present invention is admixed with other ingredients to result in a food item.

In one aspect of the present invention, the composition of the present invention is admixed to oil before heating the food therein above 120° C. in such an amount that
a) the carnosic acid is present in an amount of about 4 to 20 ppm; preferably in an amount of about 8 ppm, and
b) tocopherols are present in an amount of about 400 to 600 ppm, preferably in an amount of about 500 ppm.

For example, the composition of the present invention is admixed to oil before heating the food therein above 120° C. in such an amount that
a) the rosemary extract comprising about 4% of carnosic acid is present in an amount of about 100 to 500 ppm; preferably in an amount of about 200 ppm, and
b) tocopherols are present in an amount of about 400 to 600 ppm, preferably in an amount of about 500 ppm.

For example, the composition of the present invention is admixed to oil before heating therein food products like potato chips, french-fried potatoes, fried breaded meats, and others above 120° C.

The provision of the starting material may impact the general level of acrylamide that is formed. For potato based products for example, the selection of a starting material that has relatively low levels of reducing sugars and asparagine, the storage conditions (in particularly temperature), washing steps and others can influence the basic level of acrylamide that can be formed.

As used herein, “food” refers at least to an edible food product, such as a solid or semi-solid food stuff product known in the art.

Food encompasses the following general food categories, as defined by the Food and Drug Administration (FDA): baked goods and baking mixes, including all ready-to-eat and ready-to-bake products, flours, and mixes requiring preparation before serving; beverages, alcoholic, including malt beverages, wines, distilled liquors, and cocktail mix; beverages and beverage bases, non-alcoholic, including only special or spiced teas, soft drinks, coffee substitutes, and fruit and vegetable flavored gelatin drinks; breakfast cereals, including ready-to-eat and instant and regular hot cereals; cheeses, including curd and whey cheeses, cream, natural, grating, processed, spread, dip, and miscellaneous cheeses; chewing gum, including all forms; coffee and tea, including regular, decaffeinated, and instant types; condiments and relishes, including plain seasoning sauces and spreads, olives, pickles, and relishes, but not spices or herbs; confections and frostings, including candy and flavored frosting, marshmallows, baking chocolate, and brown, lump, rock, maple, powdered, and raw sugars; dairy product analogs, including nondairy milk, frozen or liquid creamers, coffee whiteners, toppings, and other nondairy products; egg products, including liquid, frozen, or dried eggs, and egg dishes made therefrom, i.e., egg roll, egg foo young, egg salad, and frozen multicourse egg meals, but not fresh eggs; fats and oils, including margarine, dressings for salads, butter, salad oils, shortenings and cooking oils; fish products, including all prepared main dishes, salads, appetizers, frozen multi-course meals, and spreads containing fish, shellfish, and other aquatic animals, but not fresh fish; fresh eggs, including cooked eggs and egg dishes made only from fresh shell eggs; fresh fish, including only fresh and frozen fish, shellfish, and other aquatic animals; fresh fruits and fruit juices, including only raw fruits, citrus, melons, and berries, and home-prepared “ades” and punches made therefrom; fresh meats, including only fresh or home-frozen beef or veal, pork, lamb or mutton and home-prepared fresh meat-containing dishes, salads, appetizers, or sandwich spreads made therefrom; fresh poultry, including only fresh or home-frozen poultry and game birds and home-prepared fresh poultry-containing dishes, salads, appetizers, or sandwich spreads made therefrom; fresh vegetables, tomatoes, and potatoes, including only fresh and home-prepared vegetables; frozen dairy desserts and mixes, including ice cream, ice milks, sherbets, and other frozen dairy desserts and specialties; fruit and water ices, including all frozen fruit and water ices; gelatins, puddings, and fillings, including flavored gelatin desserts, puddings, custards, parfaits, pie fillings, and gelatin base salads; grain products and pastas, including macaroni and noodle products, rice dishes, and frozen multicourse meals, without meat or vegetables; gravies and sauces, including all meat sauces and gravies, and tomato, milk, buttery, and specialty sauces; hard candy and cough drops, including all hard type candies; herbs, seeds, spices, seasonings, blends, extracts, and flavorings, including all natural and artificial spices, blends, and flavors; jams and jellies, home-prepared, including only home-prepared jams, jellies, fruit butters, preserves, and sweet spreads; jams and jellies, commercial, including only commercially processed jams, jellies, fruit butters, preserves, and sweet spreads; meat products, including all meats and meat containing dishes, salads, appetizers, frozen multicourse meat meals, and sandwich ingredients pre-pared by commercial processing or using commercially processed meats with home preparation; milk, whole and skim, including only whole, lowfat and skim fluid milks; milk products, including flavored milks and milk drinks, dry milks, toppings, snack dips, spreads, weight control milk beverages, and other milk origin products; nuts and nut products, including whole or shelled tree nuts, peanuts, coconut, and nut and peanut spreads; plant protein products, including the National Academy of Sciences/National Research Council “reconstituted vegetable protein” category, and meat, poultry, and fish substitutes, analogues, and extender products made from plant proteins; poultry products, including all poultry and poultry-containing dishes, salads, appetizers, frozen multicourse poultry meals, and sandwich ingredients prepared by commercial processing or using commercially processed poultry with home preparation; processed fruits and fruit juices, including all commercially processed fruits, citrus, berries, and mixtures; salads, juices and juice punches, concentrates, dilution, “ades”, and drink substitutes made therefrom; processed vegetables and vegetable juices, including all commercially processed vegetables, vegetable dishes, frozen multicourse vegetable meals, and vegetable juices and blends; snack foods, including chips, pretzels, and other novelty snacks; soft candy, including candy bars, chocolates, fudge, mints, and other chewy or nougat candies; soups, home-prepared, including meat, fish, poultry, vegetable, and combination home-prepared soups; soups and soup mixes, including commercially prepared meat, fish, poultry, vegetable, and combination soups and soup mixes; sugar, white, granulated, including only white granulated sugar; sugar substitutes, including granulated, liquid, and tablet sugar substitutes; and sweet sauces, toppings, and syrups, including chocolate, berry, fruit, corn syrup, and maple sweet sauces and toppings.

The composition of the present invention is used to prevent or to lower the formation of acrylamide during heating. Therefore, in one aspect of the present invention, there is provided the use of the composition as acrylamide reducing agent.

As demonstrated in examples Lamiaceace extracts rich in phenolic diterpens combined with tocopherols have a synergistic effect and can significantly lower the formation of acrylamide in potato chips. Said synergistic effect can be for example observed on Example 2.

In one example of the present invention, there is provided the use of the composition as acrylamide reducing agent, wherein the composition is applied to food before said food is heated to higher temperatures, in particular to temperatures above 120° C.

In one embodiment of the present invention, the composition of the invention is admixed with oil or fat, that is present while the food is heated, in particular heated to temperatures above 120° C.

For example, said oil or fat might be used as heating medium, for example for frying, deep frying, sautéing etc. That means that the food is brought in contact with the oil or fat comprising the composition of the invention.

Alternatively, said oil or fat might form a part of the food or composition that might later form a part of food, like a flavor composition. It means that a food stuff as such might comprise an oil or fat comprising the composition of the present invention.

The present invention is also related to a method for processing or preparing the above mentioned products (such a food) comprising applying to or incorporating into said product (such as a food), a composition of the invention comprising carnosic acid and tocopherols.

The present invention is also related to a method for processing or preparing the above mentioned products (such a food) comprising applying to or incorporating into said product (such as a food) a composition of the invention comprising at least one Lamiaceae extract such as a rosemary extract and/or salvia extract and tocopherols. In one embodiment, Lamiaceae extract comprises at least one phenolic diterpene selected from carnosic acid, carnosol, and mixtures thereof.

In one embodiment the food is selected from potato chips, french-fried potatoes, fried breaded meats, cereals, cookies, crackers, breads and rolls, and others.

In a preferred embodiment, the composition is in dry form. In another embodiment, the composition may be in a liquid form.

In one embodiment of the present invention, there is provided a composition for frying food comprising oil suitable for frying and the composition comprising carnosic acid and tocopherols.

For example, said composition for frying food comprises the oil, the carnosic acid in an amount of about 4 to 20 ppm and tocopherols in an amount of about 400 to 600 ppm. For example, the carnosic acid is present in an amount of about 8 ppm, and tocopherols in an amount of about 500 ppm.

For the avoidance of doubt, preferences, options, particular features and the like indicated for a given aspect, feature or parameter of the invention should, unless the context indicates otherwise, be regarded as having been disclosed in combination with any and all other preferences, options particular features and the like as indicated for the same or other aspects, features and parameters of the invention.

When we use the term “comprising” or “comprises” we mean that the extract or composition being described must contain the listed ingredient(s) but may optionally contain additional ingredients. When we use the term “consisting essentially of” or “consists essentially of” we mean that the extract or composition being described must contain the listed ingredient(s) and may also contain small (for example up to 5% by weight, or up to 1% or 0.1% by weight) of other ingredients provided that any additional ingredients do not affect the essential properties of the extract or composition. When we use the term “consisting of” or “consists of we mean that the extract or composition being described must contain the listed ingredient(s) only. The term “about” as used herein, e.g. when referring to a measurable value (such as an amount or weight of a particular component in the reaction mixture), refers to variations of ±20%, ±10%, ±5%, ±1%, ±0.5%, or, particularly, ±0.1% of the specified amount.

The invention is now further described with reference to the following non-limiting examples. These examples are for the purpose of illustration only and it is understood that variations and modifications can be made by one skilled in the art.

### EXAMPLES

### Example 1: Detailed Procedure for Obtaining Rosemary Extract

The detailed procedure to prepare the composition of Rosemary extract was described in the U.S. Pat. No. 5,859,293 (PCT W096/34534), which is incorporated herein by reference in its entirely. The procedure is briefly summarized as follows: The Rosemary leaf was extracted with acetone at room temperature. After the extraction was completed, the acetone extract was filtered to separate the solution from Rosemary leaf and concentrated under reduced pressure to make concentrated native extract. At this time, the concentrated extract can be dried directly in a vacuum oven under mild heat to make a powdered extract, which is a composition comprising about 15%-30% carnosic acid and 1%-3% carnosol. Or to the concentrated native extract, aqueous sodium carbonate (NaHCCh) was added to dissolve carnosic acid and other organic acids, while base insoluble substances were precipitated out. The solution was filtered to separate from solid, and the filtrate was further concentrated under reduced pressure. Once finishing concentration is achieved, phosphoric acid (H₃PO₄) was added and the acid insoluble substances (including carnosic acid, carnosol, and carnosic derivatives) were precipitated from the concentrated solution. Through filtering, the precipitated solid was subsequently separated from liquid and rinsed with water to remove impurities. Last, the solid was dried in a vacuum oven and then milled into powder which is a composition containing about 40-85% carnosic acid, 2-10% carnosol, and 2-10% 12-O-methylcarnosic acid.

### Example 2: Frying of Potato Chips

Raw potatoes were cut into slices of 1.5 mm thickness. The slices were washed with water for 5 min, then dried for 5 min at room temperature. 150 g of the slices were fried in 6 L palm oil, at 180° C. for 5 min. In samples A to F Rosemary Extract and/or tocopherols have been added to the frying oil in different amounts. The level of acrylamide was determined.

| | Rosemary extract* | | Tocopherols ** | Acrylamide |
|---|---|---|---|---|
| Sample | (carnosic acid) (ppm) | | (ppm) | (ppm) |
| Control | 0 | | 0 | 0.53 |
| A | 0 | | 500 | 0.34 |
| B | 750 | (30) | 0 | 0.56 |
| C | 1000 | (40) | 0 | 0.31 |
| D | 200 | (8) | 500 | 0.20 |

*comprising 4% carnosic acid
**tocopherol composition containing 14% alpha-, 2% beta-, 60% gamma-, and 24% delta-(δ-)-tocopherol by weight of the tocopherol composition

In the control sample, no Rosemary Extract or tocopherols have been added. The addition of only tocopherols or Rosemary Extract (Samples A to C) to the frying oil results in no or partial reduction of the acrylamide level. The lowest level of acrylamide was found in sample D, where 200 ppm of Rosemary Extract and 500 ppm of tocopherols have been added to the frying oil. This result demonstrates a synergistic effect of the combination of carnosic acid and tocopherols in the ability to lower the formation of acrylamide in heat processed food, in particular in fried potato chips.

1. (canceled)

2. (canceled)

3. (canceled)

4. (canceled)

5. (canceled)

6. (canceled)

7. A method for reducing the amount of acrylamide in a food product, wherein the method comprises applying a composition comprising
a) from about 25% to about 32% by weight of the composition of rosemary extract containing about 4% carnosic acid; and
b) from about 68% to about 75% by weight of the composition of tocopherols, to the food product.

8. The method according to claim 7, wherein the composition is applied to the food product before heating the food product above 120° C.

9. The method according to claim 8, wherein the composition is admixed with oil before heating the food product above 120° C.

10. The method according to claim 7, wherein the composition is applied to the food product in an amount that
a) the carnosic acid is present in an amount of about 4 to 20 ppm, and
b) tocopherols are present in an amount of about 400 to 600 ppm.

11. (canceled)

12. The method according to claim 7, wherein the food product is selected from the group consisting of snacks, bakery goods, potato crisps, potato fries.

13. (canceled)

14. The method according to claim 9, wherein in the oil before heating
a) the carnosic acid is present in an amount of about 4 to 20 ppm, and
b) tocopherols are present in an amount of about 400 to 600 ppm.

15. The method according to claim 7, wherein the composition reduces, delays and/or prevents the formation of acrylamide during heating above 120° C.

16. A food product for humans or animals obtained by the method according to claim 7.

17. The food product according to claim 16, wherein before the food product is heated above 120° C. the concentration of phenolic diterpene is 4 to 20 ppm, and
the concentration of tocopherols is 400 to 600 ppm.

18. An acrylamide reducing composition comprising an effective amount of carnosic acid and tocopherols.

19. (canceled)

20. (canceled)

21. The method according to claim 10, wherein the composition is applied to the food product in an amount that a) the carnosic acid is present in an amount of about 8 ppm and b) tocopherols are present in an amount of about 500 ppm.

22. The method according to claim 14, wherein in the oil before heating a) the carnosic acid is present in an amount of about 8 ppm, and b) tocopherols are present in an amount of about 500 ppm.
